(19) United States
(12) Patent Application Publication
(10) Pub. No.: US 2025/0124303 A1
(43) Pub. Date: Apr. 17, 2025

(54) STRUCTURED DATA GENERATION FOR FOUNDATION MODEL FINE-TUNING

(71) Applicant: Sunwave Health, Inc., Delray Beach, FL (US)

(72) Inventor: Elie E. Levy, Delray Beach, FL (US)

(21) Appl. No.: 18/915,170

(22) Filed: Oct. 14, 2024

Related U.S. Application Data
(60) Provisional application No. 63/590,393, filed on Oct. 13, 2023.

(51) Int. Cl. G06N 3/096; G06N 3/042; G06N 3/0475; G06N 3/09

(52) U.S. Cl. CPC G06N 3/096; G06N 3/042; G06N 3/0475; G06N 3/09

(57) ABSTRACT

Provided is a process that includes receiving, via computing system, a template form comprising one or more unpopulated health information elements and a set of populated heath information elements; determining, with a generative language model, generated information based on the set of populated heath information elements of the template form, wherein the generated information relates to a first health information element of the one or more unpopulated health information elements; sending, with the computing system to a user computing device, a message prompting the user to accept the generated information; and responsive to receiving permission from the user computing device, storing the generated information in memory.

### CROSS-REFERENCE TO RELATED APPLICATIONS

This patent application claims the benefit of U.S. Provisional Application No. 63/590,393, filed on 13 Oct. 2023, titled SYSTEM AND METHOD FOR STRUCTURED DATA GENERATION FOR FOUNDATION MODEL FINE-TUNING. The entire content of each aforementioned filing is incorporated herein by reference.

### BACKGROUND

### 1. Field

The present disclosure relates generally to machine learning and more specifically to templates that serve as language model input data structures to improve narratives generated by language models.

### 2. Description of the Related Art

Professionals, like lawyers, consultants, healthcare providers, and the like, often struggle with supplying natural language text description of their findings, efforts, and projects. In many cases, such professionals are overloaded with a diverse array of customers, patients, clients, projects, or the like, and are forced to quickly switch contexts without time to capture their thinking in written form. Similarly, generative artificial intelligence (AI) models are often chained, so that outputs of one are taken as inputs to another, e.g., to reason about some overall task, with different models specializing in aspects of a workflow. Often, such outputs include hallucinations or lack the proper context of the overall task at hand, leading downstream models astray.

Many existing text generation software tools are not well suited to aid in this effort. Many existing text generation techniques generate text statistically, which often results in outputs that are not grounded to a particular context. For example, large language models (LLMs) have a tendency to hallucinate responses or otherwise generate text that does not literally read onto any actually existing state of affairs. Consequently, outputs of large language models may in some cases may not be reliable in contexts where high fidelity is required. None of which is to suggest that models employing statistical text generation are disclaimed or that any other subject matter is disclaimed.

Improved techniques are needed to reduce the likelihood of hallucinations in language models prior to their deployment within various contexts.

### SUMMARY

The following is a non-exhaustive listing of some aspects of the present techniques. These and other aspects are described in the following disclosure.

Some aspects include a computer-implemented process of generating narratives based on received populated template forms. The process may include steps of presenting pre-generated forms that may include UI elements such as text fields, radio buttons, dropdowns, and comments. A text-to-speech system may be used to populate some aspects of the pre-generated forms. The process further includes receiving the populated form and inputting the populated form into a trained machine learning model. The trained machine learning model then may output a narrative based on the received populating template. The machine learning model may be fine-tuned based on an edited version of the narrative.

Some aspects include a process including: receiving, via computing system, a template form comprising one or more unpopulated health information elements and a set of populated heath information elements; determining, with a generative language model, generated information based on the set of populated heath information elements of the template form, wherein the generated information relates to a first health information element of the one or more unpopulated health information elements; sending, with the computing system to a user computing device, a message prompting the user to accept the generated information; and responsive to receiving permission from the user computing device, storing the generated information in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is an example computing environment within which a narrative generation system may be implemented, in accordance with some example embodiments;

FIG. 2 is an example method by which one or more machine learning models within a narrative generation system may be trained, in accordance with some example embodiments;

FIG. 3 is a physical architecture block diagram that shows an example of a computing device by which some aspects of the above techniques may be implemented in a computer system of such devices.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of natural language text generation and machine learning. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some examples below describe the present techniques with reference to a software as a service (SaaS) tool for providers of addiction recovery services, e.g., helping people with treatment for things like opioid and alcohol addiction. However, the techniques are not limited to such use cases, and it should be emphasized that similar approaches may be used in other fields of healthcare, law, consulting, or other scenarios in which a user is asked to provide natural language text descriptions or inputs and related values for fields in a form. Further, it should be emphasized that the present techniques are not directed to providing healthcare, legal services, or consulting, but rather to improvements to computer systems and related software that happen to be useful in those fields and others. Indeed, the present techniques may be applied to purely computational scenarios, divorced from relations between humans, for example, further transforming text generated by other AI models, for instance, in a chain of prompts (like with LangChain or DSPy as described in arXiv:2310.03714 and arXiv:2409.18486, which are incorporated by reference) in which one AI agent produces output supplied as input to another AI agent in a multi-agent reasoning system in which intermediate prompts are not revealed to a user.

As noted, professionals like lawyers, consultants, and healthcare providers, and AI agents in multi-agent systems may struggle with supplying natural language text description of their findings, efforts, and projects. For example, a healthcare provider may struggle to enter a good narrative describing their sessions with patients and their observations after those sessions, such as progress notes. The difficulty of entering a good narrative is often compounded when a healthcare provider has multiple patients in group sessions, and often they have relatively little time to provide these narratives after a session. Similar challenges are faced by other professionals interacting with forms or otherwise supplying natural language text descriptions with limited time or cognitive budget. In another example, an AI agent tasked with describing a scenario in which a problem is solved for downstream AI agents that will be prompted on narrative elements of that scenario in isolation might struggle with providing adequate context to each of those downstream prompts or avoiding hallucinations in those elements.

Some embodiments employ language models (like LLMs) to generate narratives based on a combination of structured data input by a healthcare provider into a form (or other user of the form), and in some cases, other unstructured natural language text supplied into the system previously. In some cases, with a properly fine-tuned or otherwise trained model, use of the structured data in model inputs is expected to yield more precise and accurate narratives without hallucinations (which is not to suggest that fine tuning or re-training is required or that any other feature described herein is required, as some embodiments may be used with off-the-shelf foundation models with other aspects described herein as part of a processing pipeline including that model).

An example SaaS system consistent with some embodiments may include a server system remote from a collection of computers at various tenant facilities which are providing services to patients (or other sources of text input, e.g., other professional services, or upstream stages of a chain of AI agents). The server system may host a website with forms with things like check boxes, radio buttons, drop-down lists, sliders, and other forms of input that provide structured data. The forms also include input boxes for text in which narratives can be entered. Some embodiments allow the user to select a “generate button” after populating the other parts of the form, and a first draft of a narrative may be generated by a large language model and inserted into the input box of the form for further editing before submission to the system as an entry in patient file.

For example, some embodiments may include a form that is used after a group therapy session, and there may be another form that is used after a one-on-one therapy session, both including such text generation features in some embodiments. Some embodiments may include more than 10, more than 100, or more than 1,000 such forms, and some embodiments support user configurable forms with a menu of elements for user inputs that the users can define to define their own forms.

In use, in some embodiments, the healthcare provider may first conduct a session with a patient, and then go to one of these forms, input the patient's unique identifier, check various boxes, or otherwise select inputs that include structured data, and then ask the system to generate a narrative based on those inputs. They may then review that proposed narrative and make edits. Those edits may be saved for further fine-tuning of the large language model, which may be done in some cases with reinforcement learning with human feedback or by adjusting the weights of the model itself.

The model may be trained, in some embodiments, on historical data in the system from previous manually generated narratives and client files, provided that such use is authorized. Some embodiments may fine-tune a foundation model using these previous inputs, for example, by redacting some or all of a narrative, and then attempting to learn to generate that narrative based upon the structured data that was input. Some embodiments may use open source models like Falcon™, Llama™ (1, 2, or 3; 7b, 70b, or 405b), Mistral™ (e.g., 7b, 8x7b, Large 2, 8x22b), or closed source models, like those offered by Anthropic™, OpenAI™, Google™, Microsoft™, or the like. Models may have more than one billion parameters in some cases, e.g., between 3 and 75 billion parameters to balance training cost with inference abilities.

Some embodiments may use speech-to-text of audio of therapy sessions, for example, using Whisper AI Models™ from OpenAI™ to transcribe audio (such as those described in arXiv:2212.04356, which is incorporated by reference), and this may be paired with speaker identification models to indicate which person is speaking. That speech-to-text output may be used in the context window with a prompt to generate the narrative. In some cases, cameras in the therapy session may enrich this data by computer vision models configured to detect and classify mood, sentiment, affect, or disposition of the patient, e.g., with the techniques described in Huang, Z Y., Chiang, C C., Chen, J H. et al. A study on computer vision for facial emotion recognition. Sci Rep 13, 8425 (2023), the contents of which are hereby incorporated by reference.

Some embodiments may generate scripts for administrators seeking insurance reimbursement based upon these inputs. Certain phrases may be more likely to result in reimbursement, and models can be trained to include those types of phrases when appropriate.

Some embodiments may augment the information in the context window with retrieval augmented generation from the entire patient file, and possibly using outside medical literature, like a medical treatise and academic publications.

Indeed, many traditional techniques employing machine learning mechanisms on social platforms are typically concerned with elevation of posts to drive user engagement, filtering of harmful content, and advertisement placement, among other metrics that are largely transactional with respect to increasing platform value based on user engagement. These machine learning mechanisms are not employed to aid users in creating content, let alone building on existing content over time.

Some embodiments may use techniques to identify data of interest from various sources for content creation. Some traditional techniques employed in other domains for identifying data of interest have traditionally relied on inputs obtained from structured data sets stored in a database, or other corpuses, to output meaningful results. Developing and curating such structured data sets is not only burdensome on users but is limited in deployment across data sets structured by different users or within different contexts, which is not to suggest that curating or any other approach is disclaimed. In many potential applications, whether existing or new or unforeseen, a preliminary task of structuring data within a structured data set for processing is often impractical. Further, many types of machine learning are particularly data inefficient, often requiring relatively large training sets to train the model. As a result, such models are often not suitable for use cases in which training data is scarce or particularly expensive to acquire.

Some embodiments employ artificial intelligence techniques tasked with the extraction (or categorization) of content items (or other identification and classification of data of interest) from various sources. Where traditional techniques have been employed for such purposes to process unstructured input data, these attempts are often characterized by a propensity to either produce erroneous results or suffer from too narrow of a focus to permit broader applicability, such as for reasons explained below, which is not to suggest that use of unstructured inputs or any other approach is disclaimed.

Unstructured inputs, like natural language texts, images, video, and the like, in contrast to structured data sets, are more difficult to process and they may warrant different weight given the precision they afford. One reason is the challenge of determining a shared context between content items in a data set, or between multiple subsets of content items within a data set that have a shared context (e.g., that relates multiple sub-contexts) between those subsets, and optimizing a model that generates a framework spanning a shared context and that structures, like in a hierarchical structure defining one or more time-series, a plurality content items. This tradeoff becomes particularly important when optimization operations are expensive, for instance, computationally, in terms of latency constraints, or in terms of time and effort of a human to develop a framework that permits exploration. Existing approaches are often not well suited for a process constrained by a relatively tight interrogation budget, i.e., where practical constraints limit the number of content items at hand to learn about a shared context. Particularly with unstructured, high-dimensionality data, existing approaches often fail to consistently infer the right shared context.

Some embodiments disclosed herein mitigate these and other issues with a computational technique that determines dynamically, while learning a framework, based on content item selections to previous prompts, when to transition from breadth of prompts (e.g., different time-series) to prioritizing depth of prompts (e.g., within a time-series) across a shared context. Optimizing machine learning techniques to navigate the combination of depth and breadth in a dynamic noisy environment of unstructured data sets has potentially profound implications on striking a balance between productive inquiry and user fatigue when developing or employing a framework to coherently organize content items which may be selected in asynchronous or unchronological ways. The techniques are expected to have wide applicability, and it is expected that a variety of forms of artificial intelligence may be improved through use of techniques that efficiently balance breadth and depth while learning. In some cases, iterative learning approaches are used both during development and employment of a framework, such as to afford user exploration and refinement of a framework during employment without a requirement to account for each possibly relevant context during initial development of the framework.

None of the preceding discussion of trade-offs should be taken to suggest that any technique is disclaimed, as the approaches described below may be implemented in combination with the various techniques described above.

To mitigate some or all of the above issues, some embodiments train one or more machine learning models (which may include one or more semi-supervised machine learning models, like a multiheaded attention transformer or state space models, among others) on a data set, or different data sets, which may include one or more existing content paths, by which a framework for generating prompts for content items may be determined. Further, embodiments employing such a framework may involve an iterative learning process that balances between depth and breadth exploration to solicit or select content items with attention to a shared context.

Translating this intuition into code, however, is non-trivial. Moravec's paradox holds that there are certain tasks that are simultaneously relatively easy for even a human child to perform (like detecting a dog in a photograph) and enormously complex and challenging for a computer to perform. This is an example of such a scenario. There is no simple mental process that may be translated directly into computer code to balance between depth and breadth for soliciting content. The dimensionality of inputs and enormous number of ways contextually relevant content may be organized or articulated can evolve and prevent the articulation of simple rules that mimic what goes on in the mind of a content creator or other entity. As such, the following should not be characterized as simply implementing a mental process with a computer, as an algorithm different from mental approaches, and one more tractable for computer operations, is used in accordance with techniques described herein.

To mitigate some or all of the above issues, some embodiments train one or more machine learning models, like language models (which may include one or more semi-supervised machine learning models, like a multiheaded attention transformer LLM like those described in arXiv:2303.08774 (which is incorporated by reference), state space models like those described in arXiv:2209.12951 (which is incorporated by reference), among others) on a data set, or different data sets, which may include one or more forms and corresponding narratives, among other content, by which narratives and other content corresponding to forms may be determined. Further, embodiments may employ an iterative training process by which machine learning models are improved based on feedback, such as user revisions and other modifications made to content generated or selected by a model.

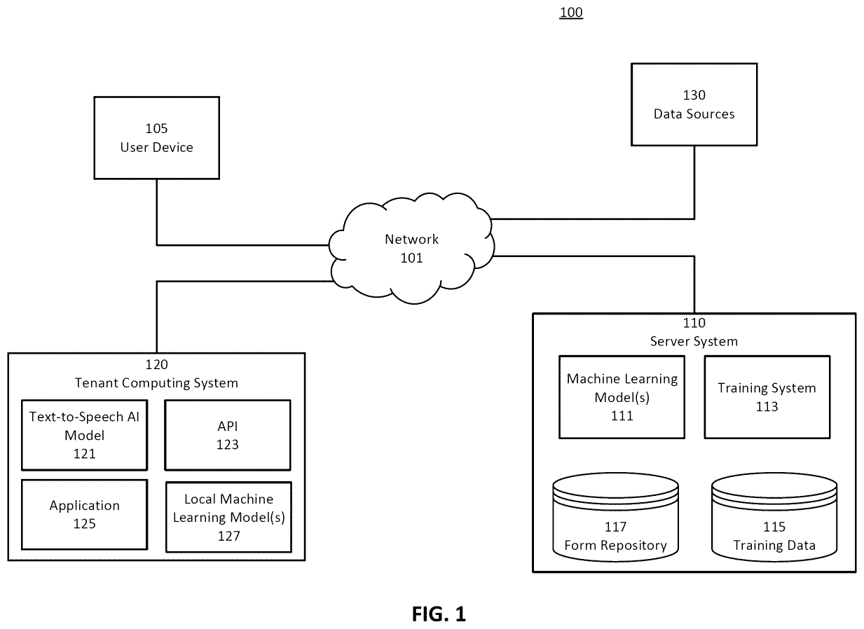

FIG. 1 illustrates an example computing environment 100 for implementing a narrative generation system in accordance with some embodiments. The computing environment 100 may include one or more user devices 105, tenant computing systems 120, server systems 110, and data sources 130. While only one of each of the aforementioned entities are shown, the narrative generation system may include multiple of such entities. For example, a plurality of user devices may communicate with a given tenant computing system among a plurality of such tenant computing systems, and a plurality of tenant computing systems may communicate with a server system, or multiple server systems, and one or more such server system may access a plurality of different data sources. Example server systems 110 (among other systems, like tenant computing systems) may include multiple compute or storage servers, or be implemented by a distributed system including multiple compute or storage nodes, and functionality or data stored may be distributed across multiple ones of nodes or servers. Each of the entities (or other components described herein) may communicate with one another (which is not to suggest that each entity or component need to communicate with every other entity or component) via a network 101, such as the internet, and various public or private local area networks. Each of these devices, sources, or systems, may include various components of computing devices or systems described herein, including a processor and memory. In some embodiments, the functionality of computing systems described herein may be implemented with program code or other instructions stored on a tangible, non-transitory, machine-readable medium, such that when that program code is executed by one or more processors, operations corresponding to the described functionality are effectuated.

Within the example environment, a server system 110 may host one or more trained machine learning models 111, which may be trained by a training system 113 using training data 115 for generating content corresponding to one or more forms which may be stored within a form repository 117. In some embodiments, the server system 110 may execute machine learning models trained by a different server system. For example, a different server system may implement the model training system 113 to train one or more models on the training data 115, and resulting trained models may be provided to the server system 110 for execution. Thus, some embodiments may distribute functionality or data depicted with reference to the server system 110, or other entities, such as tenant computing system 120, in different ways would departing from the techniques disclosed herein.

Example embodiments of training data 115 may include megabytes, gigabytes, or terabytes of data relating to one or more contextual categories of information. One or more training data sets may be generated (and augmented) for training one or more corresponding models. For example, a training data subset may be generated with respect to each contextual category of information, and one or more such training data subsets may be selected to a training data set for training a model. In various examples, a training data set may be divided into multiple portions, such as a set of training records for training an iteration of a model and a set of validation records for validating the iteration of the model. A record selected for validation (or training) of a given iteration of a model may later be used for training (or validation) of a subsequent iteration.

In some examples, training data 115 may include records related to one-on-one or group discussion sessions. For example, a discussion session may occur between one or more doctors, therapists, or other healthcare individuals and one or more patients. Other examples of discussion sessions may include legal discussions, such as between lawyers and clients, business discussions, such as between different business entities or internally within a same business entity, or board discussions, and the like. In some examples, records may include information related to such discussion sessions. For example, training data 115 may include information or labelling detailing whether an insurance claim, business decision, or other outcome related to a given discussion (or series of discussions), was successful (or unsuccessful) among other metrics related to the outcome. As an example, information indicative of an insurance claim (and characteristics of the claim, such as success and percent covered, or failure) may be associated with one or more records of discussions pertinent to the claim (e.g., based on the characteristics of the claim and characteristics of discussions involving relevant parties).

Different discussions sessions may be related to different forms. For example, a form related to healthcare services may be a patient intake form, which may be the same or different for different healthcare scenarios, such as addiction treatment, elective surgery, weight loss drug, and the like. One or more additional forms may also be associated with a healthcare scenario. For example, after an initial discussion session corresponding to intake of a patient, one or more subsequent discussions may occur and one or more additional forms which may differ from a patient intake form or other prior additional form may be used. In another example, one form may be used after a group therapy discussion session, and another form may be used after a one-on-one therapy discussion session. The principles discussed herein may also apply to different types of activities which need not specifically pertain to discussion only. For example, the disclosed techniques may be relevant to physical therapy and other types of sessions which may occur in one-on-one or group settings and in which one or more forms are used to track participants' progress.

In some examples, training data 115 may include data obtained from one or more of a variety of other data sources 130. Data obtained from data sources 130 may include structured or unstructured data, or a combination thereof, which may be included in, or utilized to generate, records for training one or more machine learning models. For example, medical record data, medical journal articles, medical research data, treatment or drug information, and the like, may be obtained and processed to augment or determine training records for training a model used to determine information for forms having a corresponding or shared context. Other examples, such as in regard to training a model to determine information for forms pertaining to legal practices, may obtain data for training records from data sources 130 that catalog various briefs, filings, laws, court transcripts and rulings, and the like. The above examples should not be constructed as limiting (which is not to suggest that other features are limiting), but rather as a non-exhaustive listing of content that may be relevant in at least some corresponding use cases, as fine-tuning different models for different forms within different contexts are expected to utilize data obtained from various different data sources 130. Some embodiments may select only records for training deemed relevant to a form or context within which a form is used, such as based on a scoring of candidate training data for relevance to a context for fine-tuning a model. For example, given a collection of training data records (e.g., completed instances of a form and related data), data obtained from other data sources may be scored for relevant and used to augment record data within the collection of training data records or generate additional training data records, which may be selected to the collection of training data records used to fine-tune a model.

Embodiments of the server system 110 may support user configurable forms, as different entities or practitioners may prefer forms with differing structure, content, and other configurable factors, even within a similar context. Accordingly, an entity utilizing the server system 110, or other computing system operating in accordance with the present techniques, may configure one or more forms for use within the context of the computing environment 100. For example, one or more existing forms, whether paper or electronic, may be imported or reproduced, or new forms may be created. In some examples, the server system 110 may store one or more form templates within the form repository 117 which may be selected and modified or otherwise configured for or by a given tenant. Example embodiments of the form repository 117 may store one or more forms corresponding to respective tenants. For example, each tenant may select or otherwise configure a plurality of forms to use within the context of the computing environment 100. In turn, a user associated with a tenant (e.g., a clinic) may select one or more forms to interact with, such as to fill out, revise, or otherwise interact with a form.

In some embodiments, a tenant computing system 120 may provide information corresponding to forms stored within form repository 117. For example, completed instances of the form (or similar forms, such as prior versions of the form) may be provided to the server system 110 by the tenant computing system 120, and information from those completed instances of the forms may be used as, or to generate, training data records within the training data 115 for training a machine learning model 111 configured to populate, summarize, or otherwise determine information corresponding to a form within the form repository 117. Additionally, as noted above, some embodiments may augment information within those training data records or generate additional training data records based on contextually relevant data obtained from other data sources 130.

The training system 113 may train one or more models, which may include various natural language processing (NLP) models, or other machine learning models (e.g., any model described elsewhere herein). For example, the training subsystem 113 may train one or more neural networks or other models for processing audio, image, text data, or other data associated with forms like those within the form repository 117, training data 115 records, or other training data content obtained from data sources 130. Examples of artificial networks that can be trained may include recurrent neural networks, convolutional neural networks, Kolmogorov-Arnold neural networks, deep neural networks, among others, which may be trained to process natural language texts or other inputs, like other types of input content items.

In some embodiments, one or more machine learning models 111 are trained on historical data from forms received from a tenant computing system 120, among other data obtained from the tenant computing system and other data sources 130. In some examples, training operations comprise fine-tuning a foundational, or other underlying model, to improve output of the foundational model within a given context, such as for one or more related forms, and in some cases, more broadly for a given tenant, or more narrowly, such as with respect to different users associated with a tenant. Examples of historical data may include, as described above and elsewhere herein, prior completed forms and associated user generated content for or based on those forms, like narratives, summaries, results, outcomes, or other contextually relevant content. In some examples, a number of different forms, or different instances of a same form (e.g., over time), may be associated by different factors, such as by context (e.g., a given healthcare concern or treatment, negotiation, activity, etc.), having a given subject entity (e.g., patient, client, etc.), collection of subject entities (e.g., two or more, like in a group or mediation), completed by a given practicing entity (e.g., doctor, nurse, lawyer, advisor, consultant, etc.), collection of practicing entities (e.g., two or more, like in collaboration), and the like. In other words, historical data including a plurality of patient or client case files, or other categories of information which may contain forms and associated information. Information, like forms and other information, corresponding to a category may be segmented in different ways to train models that account for semantic differences, such as based on context, subject entity, practicing entity, and other factors.

In some embodiments, the training system 113 trains one or more fine-tuned models based on a foundational model, such as by iterative training of a foundational model (or adapter thereof) to account for one or more factors like those described above related to a given form or a subset of forms which are represented in a subset of corresponding training data records used to train a given instance of a fine-tuned model. Other fined-tuned model instances may be trained based on other subsets of training data records pertaining to another form or another subset of forms, such as to generate a plurality of machine learning models 111 for processing data corresponding to one or more respective forms. Examples of foundational models within the context of natural language processing may include, but are not limited to, large language models (LLMs) such as GPT-3, GPT-4, o1, GPT-3.5, Chat GPT, LaMDA, LLaMA, LLaMA 2, Bloom, PaLM, Dolly, Cerebras-GPT, BERT, XLNet, and the like. Accordingly, in at least some examples, a foundational model may be a commercially available or open-source LLM, and training operations performed by the training system 113 may include generating a fine-tuned version of such a model based on additional training (e.g., by iterative training of a foundational model on a subset of training data, such as a subset of training data relative to a context within which the fine-tuned model is to be deployed for determine improved outputs within that context).

In some examples, training operations for fine-tuning a LLM may include forming training data records for the training data 115 from information obtained from one or more tenant computing systems 120 and data sources 130. For example, a plurality of training records may be formed, and selected from, for training a fine-tuned model within a corresponding context. Some embodiments may, for example, train a fine-tuned model on records of narratives and corresponding instances of a form. Some example forms may include, or be associated with, a corresponding narrative, like a pair-wise combination. A given form may include a plurality of options, text boxes, or other data fields within or by which information or data is provided responsive to corresponding descriptions or instructions. A portion of a form may be provided for additional input, like a narrative or a summary, such as based on the information or data provided to the form or other observations. Some examples of a training process may include analyzing and identifying different types of information corresponding to forms, such as to determine a narrative, summary, or other supplied text portion of information provided in a form. Some embodiments may parse a supplied text portion of information from other form content and associate that text content with data representative of other form content (e.g., like a data structure encoding other form content, which in some examples may be or include structured data). In some examples, a text portion that corresponds to a form may not be provided directly on a form and instead identified and parsed from other data, such as notes, minutes, or other documentation (e.g., that may contain a summary or narrative corresponding to the form). Some embodiments of the process determine pair-wise combinations of text portions parsed from other data sources to corresponding forms, such as based on a scoring of candidate text portions for given form contents, or vice versa, based on various factors. For example, embodiments may determine the values of one or more keys (e.g., dates, entity names, file names, file structures, etc.) identified within respective text portions and respective form contents, and then determine pairings of form content and text portions based on degree of match of values of one or more keys. In either example, embodiments may identify a text portion that corresponds to content provided for an instance of a given form.

In some example embodiments, a LLM model may be trained based on records of text portions and corresponding form contents for a given form, e.g., such that a text portion (or other natural language text for a data field of the form) may be generated (or augmented) for an instance of the form for which at least some information is known (e.g., to provide to a fine-tuned LLM model as input). Known information may be provided via the instance of the form, other data source (e.g., like notes, transcript, etc.), or combination thereof. Embodiments of the fine-tuned LLM may ingest the known information, like partial or completed form content (which may be encoded in a data structure by which form content is represented), any existing text portion content provided to the form (like natural language parsed from a given portion of the form), any other associated natural language text content (like notes, minutes, transcript, etc.), or other input information represented in the training data, and output one or more natural language texts. For example, the fine-tuned LLM may output a natural language text corresponding to a text portion, like a summary or narrative, for a form. In another examples, embodiments of the fine-tuned LLM may output a data structure having one or more other data fields populated with natural language text content, and one such data field may be for a summary or narrative. Other example data fields that may be populated with natural language text content may include one or more data fields that correspond to text boxes or other data fields within with text content may be provided on a form.

In some embodiments, natural language text may be populated for one or more data fields that correspond to options, lists, or other types of selectable content of a form. Selectable content corresponding to a data field of a form may be parsed into a natural language text description of possible selections (e.g., yes/no, rarely/sometimes/often, 1-10 or other scale, elements within a list, and the like) for the data field. Training records by which the training system 113 fine tunes a machine learning model to determine information for the form may include the natural language text of selections made on instances of the form, along with other training data like that described above. In turn, a trained machine learning model 111 (like a fine-tuned LLM) may determine a natural language text description selection among possible selections for a data field within an output data structure corresponding to a form, in addition to generating (whether by augmenting or revising prior provided content or determining new) natural language text content corresponding to other data fields that correspond to natural language text portions provided by or with a form.

Some embodiments may modify training data 115 in different ways to create training data sets. For example, a first portion of applicable training data records may be selected for training an iteration of a machine learning model 111 and a second selected portion for validating the iteration of the model may be redacted in part (e.g., different portions of form data or one or more words, sentences, or other form content may be selective omitted—for example, one or more data fields within a data structure may be redacted in whole or in part to create a redacted version). The data from the redacted validation records may be provided as input to the model to generate corresponding outputs and the accuracy of the model may be scored based on one or more measures of similarity between an output and unredacted record data. Some embodiments may, for example, convert natural language text output data and natural language text that was redacted (e.g., for a data structure, for a data field, or for one or more portions of data field content) to respective vectors, such as with Word2Vec, or other vectorization technique, and those vectors may be compared (e.g., cosine similarity or other measure) to determine a similarity score.

In some examples, a plurality of vectors may be embedded within an embedding space and one or more clustering processes may be performed to determine clusters of vectors having similar semantic content. In turn, one or more measures of similarity may be determined based on whether two vectors are members of a same cluster (e.g., vectors within a threshold distance), members of nearby clusters (e.g., two clusters within a threshold distance), and the like. In some examples, the embeddings and clustering process may account for semantic similarities and dissimilarities of words within a particular context. For example, in some embodiments, the embedding space may be trained on contextually relevant data, whether from existing completed form content, contextually relevant content obtained from data sources 130, or a combination thereof. Thus, for example, one embedding space may reflect the semantic similarity between two words (e.g., delivery and child) within a particular context (e.g., prenatal care) by their embeddings (e.g., within a threshold distance), and a different embedding space may reflect the semantic dissimilarity between those same two words within a different context (e.g., software development) by different embeddings (e.g., exceeding a threshold distance).

Notably, at least for text portions of a form (e.g., not limited to a specific set of selectable options), training and validation operations may score model outputs on their semantic accuracy and also coverage of known content, not just whether the model can fill in missing content that makes broadly literal sense. For example, in addition to scoring words, one or more phrases, sentences, and paragraphs, or other portions of text, corresponding to a data field may be represented by vectors. The collection of vectors may be embedded, such as to determine semantic coverage of the natural language text within the embedding space. Thus, for example, in addition to scoring generated text for semantic accuracy against known text content, a measure of breadth may also be determined (e.g., how many different areas within the embedding space a generated text included information about). A measure of breadth may also be determined for known content, such as to determine whether a generated text (or texts) included information from less, more, or about the same number of areas as a known text (or texts). Scores may be determined for outputs based on number of areas (and desired areas) covered (and optionally succinctness), such as to adjust breadth and succinctness of model outputs in subsequent fine-tuning training iterations for different data fields.

Further, the accuracy of the model at generating content within those different areas may also be scored, such as whether the model typically fails to generate accurate output within a given area, but often attempts to do so because those areas are represented in form training data. For example, a model may fail to determine accurate descriptions of an outward physical appearance or demeaner of a patient within a narrative, and healthcare professionals may often include descriptions of that information on a form. Embodiments may account for such scenarios in different ways, whether during training or in production. During training (and validation), embodiments may determine whether a record does not contain any information within a corresponding area (e.g., based on an embedding of record data), and may insert some placeholder text, such as “No physical appearance information reported.” In turn, model output may be scored (e.g., positively) for reproducing the above or generating text with similar semantic meaning within the output. As a result, hallucinations of the LLM in outputs may be reduced. In a production example, input data and output data may be embedded, and text content within one or more areas covered in the output data but not the input data (e.g., areas in which the model generates content that scores below a threshold) may be filtered from the output data. In some examples, the text that is filtered may be replaced with placeholder text corresponding to that area (e.g., “Please describe physical appearance”) to prompt a healthcare to provide the information during review of form content after processing by the model (e.g., prior to indicating the form as complete). Accordingly, the efficacy of an iteration of a fine-tuned model in determining contextually accurate natural language text content for text portions of a form may be scored.

Some embodiments may modify training data 115 by redacting all or some of the natural language text corresponding to one or more or text portions corresponding to a record of a form. Different redacted versions of an instance of a form may be represented in training data record, and validation of a trained model may be based in part on a measure of its accuracy of reproducing redacted portions of natural language text in validation records. Embodiments may score model outputs based on similarity measures that account for contextual accuracy and completeness of content for reproduction of redacted content, such as in accordance with scoring examples described herein. For example, some scores may reflect a high degree of accuracy based on factors other than word-for-word similarly between a reproduced text portion and original text. In some embodiments, scoring accuracy of text output by a model may be based on contextual accuracy and content completeness relative to the original content. Some embodiments may tune a model to generate text within a preferred namespace, such as by adjusting scores for output texts that contain preferred (or unfavorable) terminology. Some embodiments may perform redactions or alterations within reproduced texts or original texts corresponding to a record of a form to tune a model to a preferred namespace. For example, a reproduced text may contain unfavorable terminology (e.g., a slang or colloquial term for a medal condition). One or more of the records containing the unfavorable terminology may be redacted to omit the unfavorable terminology and one or more other records may be modified to include the preferred terminology. For example, it might be desirable that text outputs summarizing patient visits for a suspected broken arm/wrist use medical terminology (e.g., ulna fracture, radius fracture, or distal radius fracture, etc.). Accordingly, where a summary describes a “broken wrist” for a diagnosed distal radius fracture, that terminology may be redacted in some training records and replaced with “distal radius fracture” in some other training records. In turn, summary/narrative outputs determined based on those records during validation that contain “distal radius fracture” may be scored highly relative to outputs that do not contain that terminology.

Some embodiments may incorporate knowledge graphs or semantic networks. In some embodiments, a knowledge graph may include one or more networks of entities. Knowledge graphs may be made of entities including objects, events, situations, or concepts. See, e.g., Steve Hedden, Harnessing the Power of Knowledge Graphs: Enriching an LLM with Structured Data (Jul. 10, 2023) https://towardsdatascience.com, (herein incorporated by reference in its entirety); see also Unifying Large Language Models and Knowledge Graphs: A Roadmap (Jun. 14, 2023), (herein incorporated by reference in its entirety). New entities may be added to a knowledge graph, such that as expertise or knowledge in a particular field grows, the knowledge graph corresponding to that particular field may be updated to reflect that expertise or knowledge. It is expected that by combining knowledge graphs with machine learning elements, such as LLMs, respective deficiencies associated with language models and knowledge graphs may be mitigated.

As noted above, LLMs can suffer from hallucinations or may output sentences that do not have any real-world referents. LLM hallucinations may include outputting references to people or things that do not exist. For example, a LLM, responding to a prompt asking what diseases are consistent with certain symptoms, may output information referring to diseases that altogether do not exist, or diseases that exist but do not correspond to the symptoms stated in the prompt. Additionally, machine learning elements often lack interpretability. For example, it can be difficult or impossible for users to determine the inner workings of a deep neural network, as deep neural networks may include one or more hidden layers. Accordingly, users and developers alike may have difficulty understanding why a machine learning element or an LLM provided the output that it did. Moreover, machine learning elements may not have reasoning capabilities. Machine learning outputs are generally generated probabilistically rather than deductively. LLMs may be unable able to reliably perform basic arithmetic calculations. LLMs and other machine learning elements may be difficult to update; once a model is trained, it may be difficult or very expensive to retrain the model. Knowledge graphs on the other hand may suffer from completeness problems; knowledge graphs may be overly rigid and have difficulty approaching novel situations intuitively (a task that machine learning elements are equipped to perform). Knowledge graphs are associated with the ability to reason deductively; knowledge graphs may be easily updated. It is expected that combining knowledge graphs or semantic networks with machine learning elements or LLMs may generate an improvement to the overall computer system by providing a machine learning element-based system with some or all of the functionalities associated with knowledge graphs or semantic networks. Additionally, such a combination may render knowledge graph-based systems more complete and less rigid, thereby making the overall system potentially more robust in the face of novel inputs or situations. A person of ordinary skill in the art would understand that none of the above-described functionalities of LLMs, knowledge graphs, semantic networks, or machine learning elements constitutes a disclaimer. For example, it is recognized that lower-temperature LLMs may more reliably perform arithmetic calculations. Additionally, it is understood that not all knowledge graphs may present a rigidness problem. Further, it should be understood that not every embodiment containing a combination of a machine learning element, LLM, knowledge graph, or semantic network need provide every or all of the benefits described herein.

In some embodiments, a machine learning model, such as an LLM, may be trained (e.g., fine-tuned) based on information included within a knowledge graph, such as to bias outputs of the LLM towards generating content that reflects the information in a graph (e.g., reducing hallucinations). In some examples, outputs of the LLM may be scored for accuracy based on the information in a graph, whether in training, or in a production environment to indicate to users a confidence in the output of the LLM. Utility of the knowledge graph may be improved by incorporation of the information contained within the graph into the outputs of the LLM (e.g., via fine tuning of the LLM based on the knowledge graph), and the LLM may afford simplicity to quickly obtaining (e.g., via natural language request input) relevant content based on the graph that achieves secondary objectives (e.g., concision, such as whether the output corresponds to a binary, multiple choice, or free-form natural language response). As a result, the respective benefits of knowledge graphs and machine learning elements may be amplified in combination while mitigating their deficiencies.

In some embodiments, a machine learning model may be trained on a data set including knowledge graphs prior to training the machine learning model based on form data, or other implementation specific materials. Thus, in some embodiments, fine-tuning a machine learning model may comprise different stages of fine-tuning. For example, a machine learning model, like a LLM, may be tuned for performance within a given context, such as legal, medical, among others, through training based on training records of information in a knowledge graph. Then, the LLM may be tuned for performance of a task within the given context, such as generating text content corresponding to a form (or type of form) based on training records of instances of that form. Some examples may further tune a LLM to a specific form among similar types of forms.

In some embodiments, a machine learning model may be trained (e.g., tuned) based on a knowledge graph. The knowledge graph may contain expert knowledge concerning the state-of-the-art knowledge within a given context. For example, a knowledge graph within a medical context, which in some examples may be concerned with a particular medical sub-context (e.g., general practice, internal medicine, etc.) may contain information about various diseases, symptoms of the diseases, and other information relating to those diseases, such as life expectancy, quality of life, etc. Additionally, the knowledge graph may contain detailed information regarding particular patients, with entities such as patient name, gender, age, related to, is child of, is grandchild of, etc. It is expected that training a machine learning model on a data set including knowledge graphs or on a data set only including knowledge graphs may tune the outputs of the LLM, though still probabilistically generated, to more accurately reflect information and related information based on the associations between such information as encoded within knowledge graphs. Accordingly, it is expected that combinations of various techniques in accordance with examples described herein are apt to mitigate the incidence of hallucinations in LLM outputs.

In some embodiments, a knowledge graph may contain one or more entities that are populated and one or more entities that are unpopulated. A machine learning model, like an LLM in some example embodiments may, based on the one or more populated entities, determine generated information representing the most likely contents of an unpopulated entity and populate a previously unpopulated entity with the generated information. In some embodiments, the knowledge graph may contain controller entities that include criteria for when certain controlled criteria should be updated. The LLM, before populating a previously unpopulated entity, may prompt the user to determine whether the unpopulated entity should be populated with the generated information. For example, The LLM may abort populating a previously unpopulated entity or proceed with populating the previously unpopulated entity based on a user's response to the prompt. For example, if a patient's information Y is indicative of a condition X, the LLM may prompt a user with the phrase, “Have you considered whether the patient has condition X? Based on the fact that the patient exhibits/has [one or more patient information factors Y], there's a chance the patient has X.” In a similar example, the LLM may prompt a user for additional patient information, e.g., missing information, which may be indicative of whether a patient is more likely to have condition X, some other condition Z, or neither, such as where the current patient information Y is as likely to point to a set of possible outcomes (e.g., condition X, condition Z, or neither).

In some embodiments, a machine learning model 111 may populate natural language text corresponding to an unpopulated entity in the knowledge graph automatically. Some embodiments may use the LLM to populate an unpopulated entity in response to a prompt from one or more users. Some embodiments may use the LLM to populate an unpopulated entity when a threshold of one or more populated entities or types of populated entities is satisfied. In some embodiments, LLMs may be incorporated into knowledge graphs. It is expected that the incorporation of LLMs into the knowledge graph will present a benefit to the overall computer system by allowing for more complete outputs from the knowledge graphs. In some embodiments, a body of information may accumulate about respective patients, and that information may be stored in an electronic medical record system and accessed (for instance, written or read) via various application program interfaces (APIs), for instance, with a Fast Healthcare Interoperability Resources (FHIR) standard-complaint API. In some examples, information in a knowledge graph may be populated based on the information corresponding to different entities (e.g., patients) represented within the medical record system.

In some embodiments, the server system 100 may include (e.g., as training data or within another repository) a knowledge graph, or information corresponding to a knowledge graph, including one or more types of entities. In some embodiments, the server system 110 or tenant computing system 120 may include a component (not shown), or functionality within one or more depicted components, by which users may interact with a knowledge graph, which in some examples may communicate with a machine learning model via an interface, like an application programming interface. In some embodiments, one or more machine learning models may be associated with different entities or types of entities in the knowledge graph (which should not be construed as limiting, as a graph may include multiple subgraphs, each of which may be associated with a machine learning model, or organization). In an example, a first entity type may be associated with neurodevelopmental disorders and a second entity type may be associated with anxiety disorders; a first machine learning model may be an LLM trained on expert literature addressing neurodevelopmental disorders, including intellectual development disorder, global developmental delay, one or more communication disorders, autism spectrum disorder, attention-deficit hyperactivity disorder, etc; and a second machine learning model may be an LLM trained on expert literature concerning anxiety disorders, including generalized anxiety disorder (GAD), social anxiety disorder, panic disorder, and separation anxiety disorder. Additionally, the LLM may relate to broader areas of research. For example, in some embodiments, a first element type may be associated with psychological disorders listed in the DSM-5 and a second element type may be associated with autoimmune diseases; a first machine learning model may be an LLM trained on literature relating to psychology and psychiatry whereas a second machine learning model may be an LLM trained on immunology literature.

In some embodiments, a machine learning model and a knowledge graph may be hosted together on a user's local machine (e.g., tenant computing system 120 as a local machine learning model 127 and an associated knowledge graph). In other examples, a machine learning model and knowledge graph may be stored in association with a tenant account by a server system (e.g., server system 110) and executed remote from a tenant computing system 120. For example, in some embodiments, a machine learning model and a knowledge graph (e.g., functionality of the tenant computing system 120) may be stored on a remote or third-party server (e.g., server system 110 or other server system, like a cloud computing platform utilized by the tenant or to which the tenant is provided access), such that a user computing device (e.g., 105) establishes a connection with the remote or third-party server to open a session.

In some embodiments, the LLM is trained on patient files. In some embodiments, named entity recognition may be applied to the dataset, such that patient names, addresses, and other personal information is flagged. In some embodiments, the patient's personal information may be substituted for non-identifying placeholders so as to allow for the training of the LLM but prevent confidential patient information from leaking to other entities, such as other users or tenants.

In some embodiments, the server system 110 or tenant computing system 120 may be used to generate narratives for group therapy sessions. Embodiments of a tenant computing system may include a text-to-speech processing model 121, which in some examples may be a machine learning (e.g., artificial intelligence) model trained to generate individualized notes with respect to the different participants of a therapy session (or other type of group discussion, like a board meeting, conference call, etc., in other contexts). The tenant computing system 120 may take as an input from a user, such as via a user device 105, which may be a device of a doctor, leader, moderator, or other administrative party to a discussion, a selection of a form corresponding to the group discussion and input from the administrative party corresponding to the form, such as via an interface of the user device 105 and which may be received by the application programming interface 123 of the tenant computing system 120. In some examples, a form may include various check boxes, radio buttons, and various natural language text field inputs relating to, for example, a mental status exam.

In some embodiments, the speech-to-text or text-to-speech AI model 121 may parse verbal content within audio (or multimedia video) corresponding to a discussion by source (e.g., speaker) of respective verbal content. In some embodiments, text-to-speech software, such as Whisper AI™ may transcribe audio with speaker identification to indicate which person is speaking. That speech-to-text output may be used to generate form content. Thus, for example, a text-to-speech process converting the verbal content into corresponding natural language text content may tag text content with different speaker identifier tags (e.g., participant 1, 2, 3 . . . n). In turn, different instances of the form may be populated with respect to the different individuals based on the verbal input from the respective individuals. The administrative party may input additional notes on user device 105, which in some examples may be time stamped and correlated with the respective individuals of the discussion, such as based on time stamps within collected audio or video content. Thus, for example, administrative party notes may be matched to different individuals for processing in relation to a form corresponding to a respective individual. Some embodiments contemplate a plurality of participants making notes or otherwise documenting their thoughts in relation to a group discussion, and the notes from respective individuals via their respective user device may be submitted to the tenant computing system 120.

In some examples, a user device 105 may interact with an application 125 hosted by the tenant computing system 120 via an application programming interface 123, or via a web interface, or other means by which a user may interface with the tenant computing system 120. The tenant computing system 120 may process the various data inputs (e.g., transcribed audio, notes, selections already made, etc.) received in relation to a form and determine candidate selections and natural language text inputs for text content fields that may be partially completed, incomplete, or otherwise rewritten (e.g., in some examples, domain specific language may be important for various desired outcomes, and a machine learning model determining form content may be tuned to incorporate such language. For example, certain phrases make a particular insurance claim more or less likely to be denied; the machine learning model may be trained to generate narratives that decrease the likelihood that an insurance claim based on narrative text content provided on the form will be denied).

In some embodiments, a machine learning model, which may be a large language model executed locally 127 on the tenant computing system 120, may provide a context window feature to indicate to a user information about the retrieval and augmented generation of information corresponding to a form based on a patient's entire file as well as outside medical literature (e.g., a medical treatise or an academic publication). Retrieval augmented generation is an artificial intelligence framework for retrieving facts from an external knowledge base to ground LLMs. Specifically, retrieval augmented generation can be used to give users an understanding of the LLM's generative process as well as provide the LLM with accurate information. Retrieval augmented generation has two principal phases: (1) retrieval and (2) content generation. During the retrieval phase algorithms obtain information relevant to the user's prompt. In some embodiments, the system may use an open-domain setting, where indexed documents obtained from an internet based medical journal database may be retrieved. In a closed-domain setting, documents may be selected from a pre-curated database. The retrieved information is then used to augment the user's initial prompt. In some embodiments this may take the form of a doctor or nurse practitioner entering a template form to the machine learning model 127 and the retrieval augmented generation program appending the template form with information from recently published and vetted medical journals or more up-to-date insurance information.

Different models may be trained in different ways (separately or concurrently through end-to-end training), and some models may receive inputs based on the outputs of other models. Training of a model may comprise end-to-end training, or training of different stages (e.g., like sub-models) of a model (e.g., like a pipeline). Some examples may combine these approaches, such as by training a model and then including that model within a model or as a stage of a pipeline trained end-to-end. The training may be performed using data obtained by the server system 110, tenant computing systems 120, and from other data sources 130, such as over the network 101. The training system 113 may store, access, or update one or more models in various states of training from within the machine learning model 111 database, and one or more such models may be provided to tenant computing systems 120 for execution by a tenant on their own hardware (or provisioned hardware from a cloud service provider). The training system 113 may access a previously trained machine learning model (or a model undergoing training) and update the model based on newly received (or classified data) and store an updated version of the model within the machine learning models 111. The tenant computing system 120 may obtain a model from the machine learning models 111 for local execution of the machine learning model 127, such as based on tenant data in connection with a user interacting with a form. Thus, the tenant computing system 120 may access a trained model to process data. The tenant computing system 120 may provide information about the results or forms obtained with the model back to the server system 110 which in turn may be used to train another iteration (e.g., update and fine tune) of the model. Thus, the training system 113 may store or access data, such as data of one or more models 111, form repository data 117, and training data 115, and the training subsystem 113 may process such data to train models used by tenants; and tenant results may be used to further augment training data 115 for one or more models use by the tenant, such as based on the interactions of users (e.g., feedback data) with forms and generated form content (e.g., approval thereof, which may be implicit feedback from viewing or modifying narratives generated by a LLM, or other feedback mechanisms like explicit ratings in relation to accuracy of selections or content generated by the LLM). In some examples, feedback data indicative of a score (e.g., accuracy or relevancy) of a result of processing a form may be received and based on that feedback and the quality measure, the natural language text and result may be stored as training data for updating the model.

In some embodiments, a transformer model may generate narrative text in response to user inputs provided via a template form that includes various input types such as radio buttons, checkboxes, and drop-down boxes. Upon receiving the user inputs, the system may first encode the selected options into a format suitable for processing by the transformer model. Each selected input (or combinations thereof) may be mapped to a corresponding embedding, where the embedding captures the semantic meaning of the user's selection. For example, if a user selects a specific option from a drop-down box, the model may generate an embedding that corresponds to the specific option selected, while also factoring in the context provided by other selections on the form.

Once the inputs are encoded into embeddings, the transformer model may process the sequence of embeddings in a manner that preserves the relationships between the selected inputs. Positional encodings may be applied to the input sequence to ensure that the order of inputs is maintained, which may be relevant for generating coherent narrative text. The transformer model may then attend to different parts of the input sequence using multi-head attention mechanisms, where each head may focus on different aspects of the user inputs, such as dependencies between selections or the contextual influence of a checkbox selection on a radio button choice.

In the decoder phase of the transformer (for transformers having a decoder), the model may generate narrative text iteratively, one token at a time, by predicting the next token based on both the encoded inputs and the previously generated tokens. The model may use attention weights to dynamically adjust which parts of the input form it focuses on at each step of generation, allowing it to craft a narrative that reflects the user's selections. For instance, if the user selects options related to a particular scenario or theme via radio buttons, the generated text may elaborate on that theme while incorporating details from checkbox selections that further specify attributes of the scenario.

In some implementations, a feedback loop may be employed during text generation to refine the output in real-time based on intermediate text. As the narrative is generated, the system may reassess the user inputs to ensure that the narrative remains consistent with the user's choices. The generated output may be further refined through post-processing steps, such as applying grammar correction or formatting the text to align with stylistic preferences. In some embodiments, additional narrative elements may be generated based on inferred user intent, where the transformer model extrapolates beyond the explicit selections to provide a more detailed or enriched narrative.

In some embodiments, various types of attention mechanisms, such as flash attention, sliding attention, and others, may be employed to enhance the performance and efficiency of transformers or other models that process sequential data. These attention mechanisms may operate by dynamically focusing on different parts of the input sequence when generating an output, allowing the model to capture dependencies across tokens without being restricted by distance within the sequence.

Flash attention may be implemented as an optimized version of self-attention to improve memory efficiency and computational speed when handling long sequences. In some embodiments, flash attention may achieve this by using a matrix multiplication algorithm that reduces redundant memory operations. Instead of storing large intermediate matrices, some embodiments may compute the attention matrix and the output directly in a memory-efficient way, performing the attention mechanism in blocks to fit within available hardware memory constraints. This approach may allow for processing longer sequences without running into memory bottlenecks that are typical of traditional self-attention mechanisms, which require \(O(n\hat{ }2)\) memory for sequence length \(n\).

In some embodiments, attention scores are computed between each pair of tokens in the sequence based on their query, key, and value representations. The scores may determine how much influence each token should have when updating the representation of another token.

Sliding attention may be used in cases where the input sequence is too long for global attention to be computationally feasible, and the model instead focuses on local neighborhoods of tokens. In some embodiments, attention is applied in a sliding window fashion, where each token attends only to a fixed-sized window of surrounding tokens, rather than the entire sequence. This reduces the computational complexity from \(O(n\hat{ }2)\) to \(O(n\cdot w)\), where \(w\) is the size of the sliding window.

The model, in some embodiments, processes tokens in overlapping windows to ensure smooth transitions between different parts of the sequence. For example, token \(i\) may attend to tokens \(i−w/2\) through \(i+w/2\), capturing dependencies within that localized region. The sliding attention mechanism may be particularly effective in applications like language modeling for very long sequences, such as documents or speech data, where global attention may not be practical but local context is still highly relevant.

Some embodiments may use global attention. In some cases, every token in the sequence attends to every other token, resulting in full context-awareness across the sequence. The attention scores may be computed as dot products between the query and key vectors for each token, followed by a softmax normalization to weigh the contribution of each token's value vector. This full attention mechanism allows the model to capture long-range dependencies and relationships between distant tokens, but it requires \(O(n\hat{ }2)\) computations, where \(n\) is the sequence length. In some embodiments, global attention may be used in combination with more efficient forms of attention for certain layers, where longer-range dependencies are important, such as at the final layers of a transformer model.

Sparse attention mechanisms may be used to reduce the computational complexity of full attention by restricting which tokens attend to each other. Instead of every token attending to every other token, some embodiments may define a pattern or rule to limit the number of tokens a given token can attend to. For example, a token may attend only to tokens within a fixed stride or may attend only to tokens at specific positions, such as every \(k\)-th token. This sparsity may be implemented through a mask that blocks attention to tokens outside the defined pattern. Sparse attention may allow models to handle longer sequences without the full quadratic complexity of global attention while still capturing essential dependencies between selected tokens.

Memory attention may be used in some embodiments to extend the attention mechanism by incorporating an external memory structure, where the model attends not only to the input tokens but also to a set of memory slots that store information from previous time steps or iterations. This mechanism is particularly useful for handling long-range dependencies, where the memory can store important information about earlier tokens or states in the sequence that would otherwise be forgotten. In some embodiments, the memory slots may be updated dynamically during the model's forward pass, allowing the model to accumulate and attend to relevant information over time. Memory attention may be beneficial for tasks that require reasoning or maintaining a coherent narrative over extended sequences.

Cross attention may be used in some embodiments. In some cases, the model attends to tokens from a source sequence (e.g., a sequence of entries in a form) while generating tokens for a target sequence. Some embodiments may compute attention scores between the query vectors from the target sequence and the key vectors from the source sequence, guiding the generation of the target tokens based on the source information.

In some embodiments, positional encoding may be implemented in transformers to account for the sequential nature of inputs without requiring a predefined maximum length. Positional encodings may be used to provide the model with information about the position of each token in the input sequence, since transformer architectures do not inherently capture the order of tokens. These encodings may be added to the input embeddings at the start of the model's processing pipeline (e.g., a serialized representation of a populated form), allowing the model to distinguish between tokens based on their relative and absolute positions.

Positional encodings may be computed using a set of trigonometric functions that generate continuous values based on the position of each token and the dimensional index of the embedding. For example, in one implementation, the positional encoding for a token at position \(p\) may be calculated as follows: 1) For even indices \(i\) in the embedding vector, the positional encoding may be computed as \(\ sin(p/10000\hat{ }{i/d})\), where \(d\) is the dimensionality of the embedding space; 2) For odd indices (i+1\), the positional encoding may be computed as \(\ cos(p/10000\hat{ }{i/d})\). These periodic functions provide a way for the model to encode both short- and long-range positional information in a manner that can generalize to sequences of varying lengths. The frequencies of the sine and cosine waves vary smoothly across the sequence, with lower-frequency components capturing global position information and higher-frequency components capturing more localized positional relationships.

Once calculated, the positional encodings may be added element-wise to the input token embeddings. This combined input vector, which now contains both semantic and positional information, is then fed into the transformer model. The model's self-attention mechanism can then use the positional encodings to determine the relative ordering of tokens, enabling the model to attend to specific parts of the sequence in a position-aware manner. In some embodiments, positional encoding may be learned rather than predefined, where the model learns a set of positional embeddings during training that is dynamically updated based on the data. These learned embeddings may still be added to the token embeddings in the same manner, providing flexibility while still preserving positional information.

In some embodiments, a state space model (SSM) may generate narrative text by modeling the generation process as a sequence of latent states that evolve over time, with each state capturing relevant information about the previous context and influencing the output at each step. Some embodiments may maintain a dynamic state vector that encodes information about the sequence of tokens generated so far, and this state is updated as new tokens are generated. The process may include transitioning between hidden states based on certain dynamics, followed by an observation model that produces the output (i.e., the next token in the text) based on the current state.

Some embodiments may include a set of state transition equations that govern how the latent state evolves from one time step to the next. In one implementation, the state transition at time step \(t\) may be defined as:

sₜ₊₁=Asₜ+Buₜ

where: sₜ is the latent state vector at time step t, A is a learned transition matrix that determines how the previous state sₜ influences the next state sₜ₊₁, uₜ represents external inputs or controls (such as embeddings of prior generated tokens), and B is a matrix that weights the input influence on the state transition.

The latent state sₜ may serve as a compact representation of the current context of the text generation process. The transition matrix A may encode learned patterns of how states evolve, capturing relationships such as word order, grammar rules, and semantic coherence in the generated text. At each step, the state vector is updated to incorporate both the previous state and the new input, which may represent the most recently generated token or other contextual information.

Once the state has been updated, an observation model may be applied to generate the next token. The observation model, such as a neural network like a softmax layer, may map the latent state sₜ to a probability distribution over the vocabulary, representing the likelihood of different tokens being the next word in the sequence. The model may then sample or select the most likely token based on this distribution. The newly generated token is then used to update the input uₜ for the next time step, and the process continues iteratively until the full text is generated.

The state space model may allow for flexibility in capturing long-term dependencies in text generation. The learned transition matrix A may be designed to capture long-range interactions, ensuring that the latent state reflects both recent tokens and earlier tokens that may still influence the overall narrative. In some embodiments, the model may also include stochastic components, where the state transition incorporates random noise or variability to introduce diversity in the generated text. The state space approach may also integrate additional components, such as attention mechanisms, that allow the model to dynamically weigh the importance of certain past states or inputs when generating the next token. This may allow the model to generate text that is both contextually appropriate and semantically coherent over long sequences. In some implementations, the latent state vector may include multiple dimensions, each tracking different aspects of the text generation process, such as syntactic structure, topic relevance, or sentiment. These dimensions may evolve independently, with the observation model combining them to predict the next token in a way that captures the complex dependencies in human language.

Similar to how the forms may constrain human inputs to shape the output of generative narratives to be more reliable, semi-structured or structured input data from one AI model to another in a chain of such AI models may be used to afford similar benefits in systems unrelated to healthcare, professional services or other interactions with humans. Upstream AI agents may be prompted, trained, or both to produce structured outputs corresponding to the partially populated forms above in some cases.

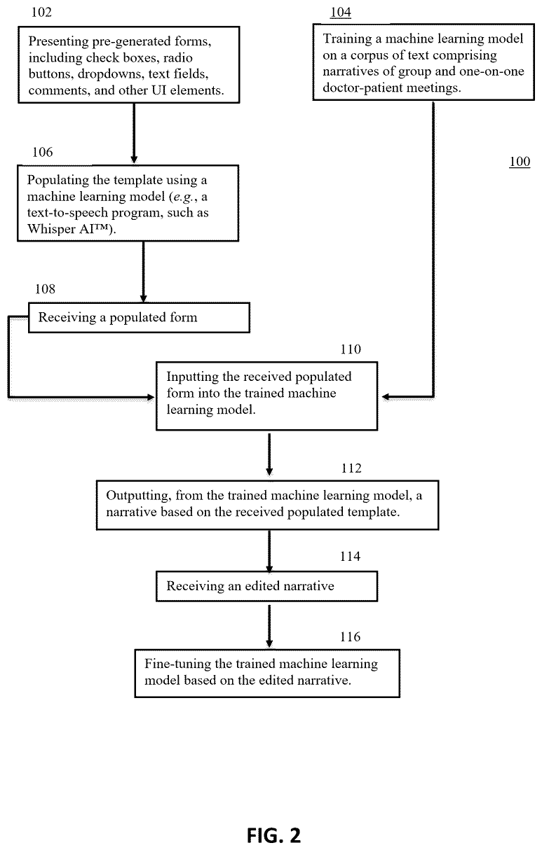

FIG. 2 is an example method for utilizing a narrative generation system in accordance with some embodiments. The process may include the step 102 of presenting pre-generated forms, including check boxes, radio buttons, drop down lists, text fields, comments, and other UI elements by which the user may select among pre-determined values for each of a plurality of fields. Once a user has been presented with and selected a pre-generated form or chosen a desired custom created template, text input boxes in the template may be automatically populated via a speech-to-text AI model (as in step 106) or may be manually populated by the user. Additionally, a machine learning model may be trained 104 on a corpus of text comprising narratives of group and one-on-one patient-doctor interactions, as well as successful and unsuccessful insurance claims based on those narratives. The populated template form may then be received 108 and input 110 into the trained machine learning model, which may then output 112 a narrative based on the status of the populated UI elements in the template form. An edited version of the narrative may be received 114 or alternatively the narrative may be compared against a model narrative. Either the edited version of the narrative or differences between the model narrative and the machine learning model generated narrative may be used to fine-tune 116 the machine learning model.

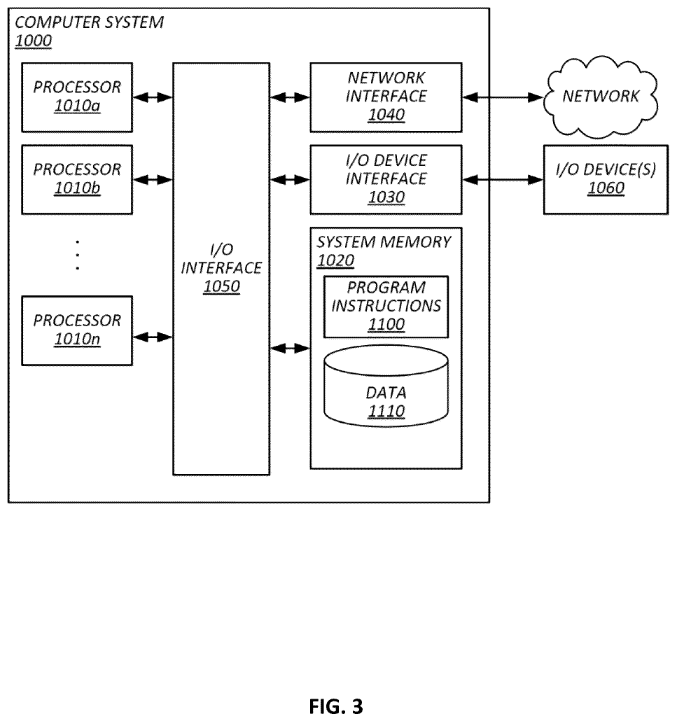

FIG. 3 is a physical architecture block diagram that shows an example of a computing device (or other data processing system) by which some aspects of the above techniques may be implemented. Various portions of systems and methods described herein may include or be executed on one or more computer systems similar to computing system 1000. Further, processes and modules or subsystems described herein may be executed by one or more processing systems similar to that of computing system 1000.

In some embodiments, a medical professional, which may include a doctor, registered nurse, physician's assistant, or other healthcare personnel, may provide an audio description of a session. The system 200 may be configured to receive the unstructured audio signal and populate one or more blanks, one or more radio buttons, one or more drop down menus, etc in the template form.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine-readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompass substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A non-transitory, computer-readable medium comprising instructions that, when executed, effectuate operations comprising: receiving, via computing system, a template form comprising one or more unpopulated health information elements and a set of populated heath information elements; determining, with a generative language model, generated information based on the set of populated heath information elements of the template form, wherein the generated information relates to a first health information element of the one or more unpopulated health information elements; sending, with the computing system to a user computing device, a message prompting the user to accept the generated information; and responsive to receiving permission from the user computing device, storing the generated information in memory.

2. The medium of embodiment 1, wherein: the form relates to addiction treatment; and the generated information comprises a narrative description of a given patient to whom the form pertains.

3. The medium of embodiment 1, wherein receiving, via the computing system, a template form comprises: appending one or more knowledge graph entities to a knowledge graph, wherein the knowledge graph comprises one or more knowledge graph entity types.

4. The medium of embodiment 3, wherein: the knowledge graph comprises a criterion knowledge graph entity, the criterion knowledge graph entity comprising one or more criteria for populating a target knowledge graph entity.

5. The medium of embodiment 4, the operations further comprising: receiving the one or more criteria of the criterion knowledge graph entity from an expert-knowledge rules engine.

6. The medium of embodiment 4, wherein the target knowledge graph entity comprises a patient disease status.

7. The medium of embodiment 6, wherein: the criterion knowledge graph entity comprises diagnostic criteria associated with the patient disease status.

8. The medium of embodiment 2, the operations further comprising: appending knowledge graph entities to a knowledge graph responsive to receiving a request from a user computing device.

9. The medium of embodiment 1, the operations further comprising: training the generative language model on a dataset comprising knowledge graph elements.

10. The medium of embodiment 1, the operations further comprising training the generative language model on a plurality of patient data training records, wherein training the generative language model on the patient data training records comprises: classifying, by named entity recognition, data within the patient data training records as being patient identifying information; and replacing the patient identifying information with generic placeholder data.

11. The medium of embodiment 1, wherein the computing system is co-located with the user computing device.

12. The medium of embodiment 1, the operations further comprising: generating, with the generative language model, a session narrative based on the template form; and sending, with the computing system, the session narrative to the user computing device.

13. The medium of embodiment 12, the operations further comprising: receiving, with the computing system, a revised session narrative; and fine-tuning the machine learning model based on the revised session narrative.

14. The medium of embodiment 1, wherein: the computing system comprises a server system remote from the user computing device, and the server system comprises a form template repository comprising one or more template form types.

15. The medium of any one of embodiments 1-14, wherein the user computing device comprises: a speech-to-text artificial intelligence model used to populate some of the information elements.

16. The medium of embodiment 15, the operations further comprise: receiving, with the user computing device, audio information from the user; outputting from the speech-to-text artificial intelligence model second generated information; receiving, with the computing system from the user computing device, the second generated information; and populating, with the computing system, a second health information element of the one or more unpopulated health information elements.

17. A method comprising the operations of any one of embodiments 1-16.

18. A computer system comprising one or more processors and memory storing instructions that when executed by the processors effectuate the operations of any one of embodiments 1-16.

What is claimed is:

1. A non-transitory, computer-readable medium comprising instructions that, when executed, effectuate operations comprising:
receiving, via computing system, a template form comprising one or more unpopulated health information elements and a set of populated heath information elements;
determining, with a generative language model, generated information based on the set of populated heath information elements of the template form, wherein the generated information relates to a first health information element of the one or more unpopulated health information elements;
sending, with the computing system to a user computing device, a message prompting the user to accept the generated information; and
responsive to receiving permission from the user computing device, storing the generated information in memory.

2. The medium of claim 1, wherein:
the form relates to addiction treatment; and
the generated information comprises a narrative description of a given patient to whom the form pertains.

3. The medium of claim 1, wherein receiving, via the computing system, a template form comprises:
appending one or more knowledge graph entities to a knowledge graph, wherein the knowledge graph comprises one or more knowledge graph entity types.

4. The medium of claim 3, wherein:
the knowledge graph comprises a criterion knowledge graph entity, the criterion knowledge graph entity comprising one or more criteria for populating a target knowledge graph entity.

5. The medium of claim 4, the operations further comprising:
receiving the one or more criteria of the criterion knowledge graph entity from an expert-knowledge rules engine.

6. The medium of claim 4, wherein the target knowledge graph entity comprises a patient disease status.

7. The medium of claim 6, wherein:
the criterion knowledge graph entity comprises diagnostic criteria associated with the patient disease status.

8. The medium of claim 2, the operations further comprising:
appending knowledge graph entities to a knowledge graph responsive to receiving a request from a user computing device.

9. The medium of claim 1, the operations further comprising:
training the generative language model on a dataset comprising knowledge graph elements.

10. The medium of claim 1, the operations further comprising training the generative language model on a plurality of patient data training records, wherein training the generative language model on the patient data training records comprises:
classifying, by named entity recognition, data within the patient data training records as being patient identifying information; and
replacing the patient identifying information with generic placeholder data.

11. The medium of claim 1, wherein the computing system is co-located with the user computing device.

12. The medium of claim 1, the operations further comprising:
generating, with the generative language model, a session narrative based on the template form; and
sending, with the computing system, the session narrative to the user computing device.

13. The medium of claim 12, the operations further comprising:
receiving, with the computing system, a revised session narrative; and
fine-tuning the machine learning model based on the revised session narrative.

14. The medium of claim 1, wherein:
the computing system comprises a server system remote from the user computing device, and
the server system comprises a form template repository comprising one or more template form types.

15. The medium of claim 1, wherein the user computing device comprises:
a speech-to-text artificial intelligence model used to populate some of the information elements.

16. The medium of claim 15, the operations further comprise:
receiving, with the user computing device, audio information from the user;
outputting from the speech-to-text artificial intelligence model second generated information;
receiving, with the computing system from the user computing device, the second generated information; and
populating, with the computing system, a second health information element of the one or more unpopulated health information elements.

17. The medium of claim 1, the operations comprising:
steps for generating a session narrative.

18. The medium of claim 1, the operations comprising:
steps for training the generative language model.

19. The medium of claim 1, the operations comprising:
steps for generating text.

20. A method, comprising:
receiving, via computing system, a template form comprising one or more unpopulated health information elements and a set of populated heath information elements;
determining, with a generative language model, generated information based on the set of populated heath information elements of the template form, wherein the generated information relates to a first health information element of the one or more unpopulated health information elements;
sending, with the computing system to a user computing device, a message prompting the user to accept the generated information; and
responsive to receiving permission from the user computing device, storing the generated information in memory.
